(19) United States
(12) Patent Application Publication
(10) Pub. No.: US 2014/0150560 A1
(43) Pub. Date: Jun. 5, 2014

(54) MEMS Pressure Sensor Assembly with Electromagnetic Shield

(71) Applicant: Robert Bosch GmbH, Stuttgart (DE)

(72) Inventors: Gary O'Brien, Palo Alto, CA (US); Ando Feyh, Palo Alto, CA (US); Andrew Graham, Redwood City, CA (US)

(73) Assignee: Robert Bosch GmbH, Stuttgart (DE)

(21) Appl. No.: 14/091,509

(22) Filed: Nov. 27, 2013

Related U.S. Application Data
(60) Provisional application No. 61/732,273, filed on Nov. 30, 2012.

(51) Int. Cl. G01L 9/14

(52) U.S. Cl. CPC G01L 9/14
USPC 73/728

(57) ABSTRACT

A pressure sensor assembly includes a pressure sensor die and a circuit die. The pressure sensor die includes a MEMS pressure sensor and an electromagnetic shield layer. The circuit die includes an ASIC configured to generate an electrical output corresponding to a pressure sensed by the MEMS pressure sensor. The ASIC is electrically connected to the pressure sensor die. The electromagnetic shield is configured to shield the MEMS pressure sensor and the ASIC from electromagnetic radiation.

This application claims priority under 35 U.S.C. §119 to U.S. Provisional Application No. 61/732,273, filed on Nov. 30, 2012, the disclosure of which is incorporated herein by reference in its entirety.

### FIELD

This disclosure relates generally to semiconductor devices and particularly to a microelectromechanical system (MEMS) pressure sensor.

### BACKGROUND

MEMS have proven to be effective solutions in various applications due to the sensitivity, spatial and temporal resolutions, and lower power requirements exhibited by MEMS devices. Consequently, MEMS-based sensors, such as accelerometers, gyroscopes, acoustic sensors, optical sensors, and pressure sensors, have been developed for use in a wide variety of applications.

MEMS pressure sensors typically use a deformable membrane that deflects under applied pressure. For capacitive pressure sensors, an electrode on the membrane deflects toward a fixed electrode under increasing pressure leading to a change in the capacitance between the two electrodes. This capacitance is then measured to determine the pressure applied to the deformable membrane. Similarly, capacitive microphones respond to acoustic vibrations that cause a change in capacitance.

While the MEMS sensor described above is suitable for most applications, the basic device structure and the electrical circuit that is used to determine the pressure measured by the sensor may be susceptible to disturbances resulting from electromagnetic fields. Sometimes the disturbances resulting from electromagnetic fields negatively influence the MEMS sensor performance.

In view of the foregoing, it would be beneficial to provide a MEMS pressure sensor that exhibits a high degree of electromagnetic compliance. It would be further beneficial if such a pressure sensor did not require significant additional space. A MEMS pressure sensor exhibiting a high degree of electromagnetic compliance, which can be fabricated with known fabrication technology would be further beneficial.

### SUMMARY

According to an exemplary embodiment of the disclosure, a pressure sensor assembly includes a pressure sensor die including (i) a fixed electrode, (ii) a movable electrode located below the fixed electrode, and (iii) an electromagnetic shield located above the fixed electrode.

According to another exemplary embodiment of the disclosure, a pressure sensor assembly includes a pressure sensor die and a circuit die. The pressure sensor die includes a MEMS pressure sensor and an electromagnetic shield layer. The circuit die includes an ASIC configured to generate an electrical output corresponding to a pressure sensed by the MEMS pressure sensor. The ASIC is electrically connected to the pressure sensor die.

### BRIEF DESCRIPTION OF THE FIGURES

The above-described features and advantages, as well as others, should become more readily apparent to those of ordinary skill in the art by reference to the following detailed description and the accompanying figures in which:

FIG. 1 is a perspective view of a MEMS pressure sensor assembly, as described herein, having an electromagnetic shield portion configured to block electromagnetic radiation;

FIG. 2 is a cross-sectional view taken along line II-II of FIG. 1; and

FIG. 3 is a cross-sectional view taken along a line similar to the line II-II of FIG. 1, showing another embodiment of a MEMS pressure sensor assembly, as described herein, having an electromagnetic shield portion configured to block electromagnetic radiation.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that this disclosure includes any alterations and modifications to the illustrated embodiments and includes further applications of the principles of the disclosure as would normally occur to one skilled in the art to which this disclosure pertains.

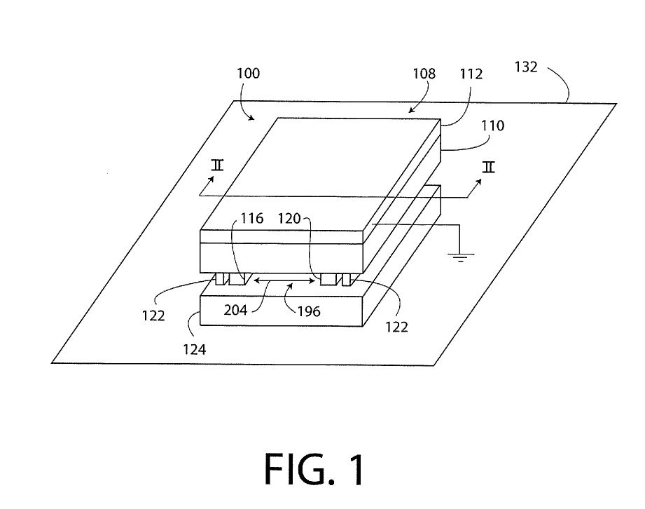

As shown in FIG. 1, a pressure sensor assembly 100 includes a pressure sensor die 108, two conducting members 116, 120, a bonding member 122, and a circuit die 124. The pressure sensor assembly 100 is shown positioned on a substrate 132, such as a printed circuit board or any other substrate that is suitable for mounting electrical components.

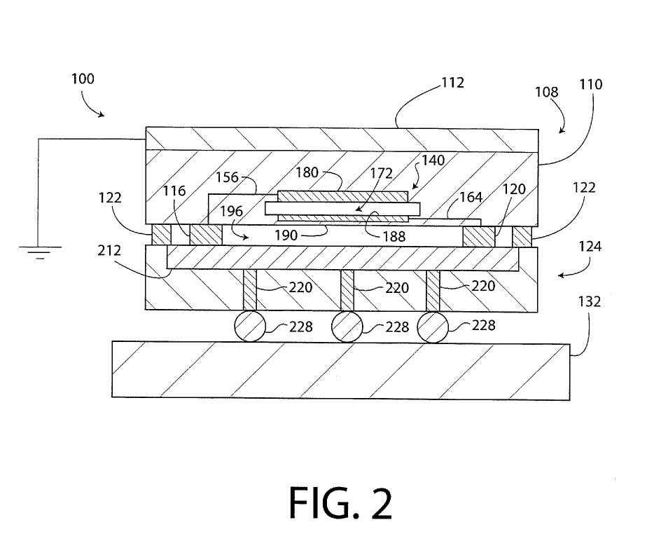

With reference to FIG. 2, the pressure sensor die 108 includes a sensor portion 110 and an electromagnetic shield 112. The sensor portion 110, which may be formed from silicon, includes at least one MEMS pressure sensor 140. In the illustrated embodiment, the pressure sensor 140 is a capacitive pressure sensor that is configured to sense pressure using capacitive transduction principles; however, in other embodiments, the sensor portion 110 includes any desired type of MEMS sensor including, but not limited to, other types of pressure sensors, accelerometers, gyroscopes, acoustic sensors, and optical sensors.

The pressure sensor 140 includes a lower movable electrode 188, an upper fixed electrode 180, and a cavity 172 located therebetween. As shown in FIG. 2, the movable electrode 188 is located below the fixed electrode 180 on a first side (i.e. a lower side) of the pressure sensor die 108. The moveable electrode 188 is electrically conductive and, in one embodiment, is located on a movable epitaxial silicon membrane 190. Accordingly, the movable electrode 188 is configured to be movable with respect to the fixed electrode 180 in response to movement of the membrane 190. The movable electrode 188 is preferably made of an electrically conductive material that is deposited/formed on the membrane 190, but may be made of any desired material. In one embodiment, the movable electrode 188 defines an area of approximately 0.01-1.0 square millimeter (0.01-1.0 mm²) and has a thickness of approximately one micrometer to twenty micrometers (1.0-20 μm).

The fixed electrode 180 is spaced apart from the movable electrode 188 and is located between the movable electrode and the shield 112. The fixed electrode 180 is preferably made of a conductive material, such as epitaxial silicon that is doped to be highly conductive, but may be made of any desired material. The area of the upper electrode 180 is approximately the same as the area of the movable electrode 188.

The cavity 172 located between the movable electrode 188 and the fixed electrode 180 is typically maintained at or near vacuum; accordingly, the pressure sensor 140 is configurable as an absolute pressure sensor. In other embodiments, the cavity 172 is at a pressure level other than at or near vacuum, depending on the operating environment of the pressure sensor assembly 100, among other factors.

With continued reference to FIG. 2, the electromagnetic shield 112 is an electrically conductive layer/portion of the pressure sensor die 108 that is located above the fixed electrode 180. In one embodiment, the shield 112 is electrically connected to ground or to another reference potential. Additionally, the electromagnetic shield 112 is substantially/completely imperforate. Typically, the electrical resistivity of the shield 112 is below one ohm·centimeter (1.0 Ω·cm) and is ideally below 0.1 ohm·centimeter (0.1 Ω·cm). The shield 112, in the embodiment of FIG. 2, is spaced apart from the first side (the lower side) of the pressure sensor die 108.

The shield 112 may be formed by doping a region of the upper die assembly 108 to be highly electrically conductive. In another embodiment, the shield 112 is formed by using a doped silicon layer located on an insulating film (not shown) that is positioned above the sensor portion 110 of the upper die assembly 108.

As shown in FIGS. 1 and 2, the conducting members 116, 120 are positioned between the pressure sensor die 108 and the circuit die 124 and are electrically isolated from each other. The conducting member 116 is electrically connected to the fixed electrode 180 by an electrical lead 156, and the conducting member 120 is electrically connected to the movable electrode 188 by an electrical lead 164. Accordingly, the conducting members 116, 120 electrically connect the pressure sensor die 108 to the circuit die 124. The conducting members 116, 120 are formed from a conductive portion of the pressure sensor die 108, solder, or any other metal or conductive material, such as silicon doped to be electrically conductive.

The bonding member 122 is located between the pressure sensor die 108 and the circuit die 124 and is configured to structurally connect the pressure sensor die to the circuit die in a stacked configuration using, for example, a eutectic bonding procedure. The bonding member 122 spaces the pressure sensor die 108 apart from the circuit die 124, such that a cavity 196 is defined therebetween. A gap 204 (FIG. 1) between the conducting members 116, 120 and the bonding member 122 exposes the cavity 196 to the atmosphere surrounding the pressure sensor assembly 100 (or to the fluid surrounding the pressure assembly 100). It is noted that in another embodiment, the structural connection of the pressure sensor die 108 to the circuit die 124 is accomplished through a thermo-compression bonding procedure. In yet another embodiment, the structural connection of the pressure sensor die 108 to the circuit die 124 is accomplished through solid-liquid-interdiffusion bonding or through metallic soldering, gluing, and/or using solder balls. In a further embodiment, the bonding member 122 and the conducting members 116, 120 are applied to the circuit die 124 (or the pressure sensor die 108) during the same fabrication step when forming the pressure sensor assembly 100. In another embodiment, the bonding member 122 and the conducting members 116, 120 are the same/identical, such that a single structure (not shown) is configured as both the bonding members and the conducting members.

The circuit die 124 includes an ASIC 212, and defines a plurality of through silicon vias 220. The ASIC 212 is electrically connected to the pressure sensor 140 through the conducting members 116, 120. The ASIC 212 is configured to generate an electrical output that corresponds to a pressure sensed by the pressure sensor 140. As shown in FIGS. 1 and 2, the “footprint” of pressure sensor die 108 is approximately equal to the footprint of the circuit die 124. In another embodiment, the footprint of the pressure sensor die 108 is sized differently (either smaller or larger) than the footprint of the circuit die 124.

The through silicon vias 220 are configured to convey the electrical output of the pressure sensor assembly 100 (including the output of the ASIC 212) to an external circuit (not shown). Additionally, the through silicon vias 220 may receive electrical signals from the external circuit, such as signals for configuring the ASIC 212. The pressure sensor assembly 100 is shown as including three of the through silicon vias 220, it should be understood, however, that the circuit die 124 includes any number of the through silicon vias as is used by the ASIC 212.

As shown in FIG. 2, solder balls 228 may be used to structurally and electrically connect the pressure sensor assembly 100 directly to the substrate 132 without the pressure sensor assembly being mounted in a package or a housing. The solder balls 228 are positioned to make electrical contact with the through silicon vias 220, in a process known to those of ordinary skill in the art. This mounting scheme is referred to as a bare-die mounting/connection scheme. Since the pressure sensor assembly 100 is not mounted in a ceramic or pre-mold package, the manufacturing costs of the pressure sensor assembly are typically less than the manufacturing costs associated with conventional packaged pressure sensor assemblies.

A method of fabricating the pressure sensor assembly 100 includes forming the electromagnetic shield 112 portion of the pressure sensor die 108. As described above, the shield 112 is formed by doping an upper layer of the pressure sensor die 108 to be highly conductive. Any desired doping process may be used to form the shield 112.

In an alternative embodiment, the shield 112 includes a highly conductive metallization coating/metalized layer that is formed using sputtering, atomic layer deposition (ALD), or silicidation. In sputtering, a source material is bombarded with energetic particles that cause atoms of the source material to transfer to a target surface (i.e. the upper surface of the pressure sensor die 108). Exemplary, source materials include metals, such as nickel (Ni), titanium (Ti), cobalt (Co), molybdenum (Mo), platinum (Pt) and/or any other desired metal or metals. For example, platinum may be sputtered onto the pressure sensor die 108 to form the shield 112 as an imperforate layer of platinum. Chemical and mechanical polishing (CMP) may be used to shape the shield 112 and/or to remove sputtered material from the pressure sensor die 108.

When ALD is used to form the shield portion 112, conforming layers of a source material are deposited onto the pressure sensor die 108. In general, ALD is used to deposit materials by exposing a substrate (such as the pressure sensor die 108) to several different precursors sequentially. A typical deposition cycle begins by exposing the substrate to a precursor “A” which reacts with the substrate surface until saturation. This is referred to as a “self-terminating reaction.” Next, the substrate is exposed to a precursor “B” which reacts with the surface until saturation. The second self-terminating reaction reactivates the surface. Reactivation allows the precursor “A” to react again with the surface. Typically, the precursors used in ALD include an organometallic precursor and an oxidizing agent such as water vapor or ozone.

The deposition cycle results, typically, in one atomic layer being formed on the substrate. Thereafter, another layer may be formed by repeating the process. Accordingly, the final thickness of the conforming layer is controlled by the number of cycles a substrate is exposed to. Moreover, deposition using an ALD process is substantially unaffected by the orientation of the particular surface upon which material is to be deposited. Accordingly, an extremely uniform thickness of material may be realized both on the upper and lower horizontal surfaces and on the vertical surfaces. In one embodiment, ALD is used to deposit platinum onto the pressure sensor die 108, such that the shield 112 is formed as an imperforate layer of platinum. CMP may be used to shape the shield 112 and/or to remove deposited material from the pressure sensor die 108.

As noted above, the shield 112 may be formed, in some embodiments, by converting a portion of the pressure sensor die 108 to silicide, which is highly conductive. To form the shield 112 from a silicide layer, first a silicide forming material is applied to the pressure sensor die 108. The silicide forming material is a material that reacts with silicon (Si) in the presence of heat to form a silicide compound including the silicide forming material and silicon. Some common metals in this category include nickel (Ni), titanium (Ti), cobalt (Co), molybdenum (Mo), and platinum (Pt). The silicide forming material may be deposited by atomic layer deposition (ALD) to form the conforming layer.

The above processes are exemplary processes suitable for forming the electromagnetic shield 112. Of course, the shield 112 may alternatively be formed by any desired process.

In operation, the pressure sensor assembly 100 senses the pressure of a fluid (not shown) located in the atmosphere surrounding the pressure sensor assembly. In particular, the pressure sensor assembly 100 exhibits an electric output that corresponds to the pressure imparted on the membrane 190 (and the movable electrode 188) by the fluid in the cavity 196. The pressure of the fluid in the cavity 196 causes the movable electrode 188 and the membrane 190 to move relative to the fixed electrode 180. Under ambient pressure conditions, the movable electrode 188 is spaced apart from the fixed electrode 180 by approximately one micrometer (1 μm). Typically, an increase in pressure causes the movable electrode 188 to move closer to the fixed electrode 180. This movement results in a change in capacitance between the fixed electrode 180 and the moveable electrode 188. The epitaxial silicon membrane 190 in combination with the capacitive transduction principle makes the pressure sensor 140 mechanically robust, as compared to other types of pressure sensors.

The ASIC 212 exhibits an electrical output signal that is dependent on the capacitance between the fixed electrode 180 and the movable electrode 188. The electrical output signal of the ASIC 212 changes in a known way in response to the change in capacitance between the fixed electrode 180 and the movable electrode 188. Accordingly, the electrical output signal of the ASIC 212 corresponds to the pressure exerted on the membrane 190 by the fluid in the cavity 196.

As a result of the shield portion 112, the sensor portion 110, the ASIC 212, and the electrical leads 156, 164 are substantially unaffected by an electromagnetic field and electromagnetic radiation imparted on or near the pressure sensor assembly 100. This is because the shield portion 112 functions as a Faraday Cage/Faraday Shield that at least partially shields the pressure sensor 140 and the ASIC 212 from electromagnetic radiation. Since the shield portion 112 is imperforate, the shield portion effectively shields the sensor portion 110 from virtually all wavelengths of electromagnetic radiation. The shield portion 112 shields the pressure sensor 140, the ASIC 212, and the electrical leads 156, 164 by directing any surrounding electromagnetic radiation to ground.

The shield portion 112 is an inexpensive way to shield the sensor portion 110, the ASIC 212, and the electrical leads 156, 164 from electromagnetic fields/radiation without increasing the size of the pressure sensor assembly 100. In comparison, other pressure sensors are positioned in a “metal can package” to shield them from electromagnetic fields. Metal can packages work well as an electromagnetic shield; however, these types of packages are expensive and bulky. The pressure sensor assembly 100 functions at least as well as a sensor assembly positioned within a metal can package; however, the pressure sensor assembly 100 is smaller, lighter, less expensive, easier to manufacture, and easier to mount onto the substrate 132.

Since the pressure sensor assembly 100 is not mounted in a package it exhibits a comparatively small size as compared to other package-mounted pressure sensor assemblies. In particular, the contact area of the pressure sensor assembly 100 that is positioned against the substrate 132 is less than approximately two square millimeters (2.0 mm²). Additionally, the height of the pressure sensor assembly is less than approximately one millimeter (1 mm). It is noted that in one embodiment the height is less than 1.0 mm even when the pressure sensor assembly 100 is electrically connected to the substrate 132, since wire bonds are not used to electrically connect the pressure sensor assembly. Furthermore, since the movable electrode 188 is facing the ASIC 212, the pressure sensor assembly 100 does not include (in the illustrated embodiment) a protective housing, since the circuit die 124 and the pressure sensor die 108 protect the membrane 190.

The comparatively small size of the pressure sensor assembly 100 makes it particularly suited for consumer electronics, such as mobile telephones and smart phones. Additionally, the robust composition of the pressure sensor assembly 100 makes it useful in automotive applications, such as tire pressure monitoring systems, as well as any application in which a very small, robust, and low cost pressure sensor is desirable. Furthermore, the pressure sensor assembly 100 may be implemented in or associated with a variety of applications such as home appliances, laptops, handheld or portable computers, wireless devices, tablets, personal data assistants (PDAs), MP3 players, camera, GPS receivers or navigation systems, electronic reading displays, projectors, cockpit controls, game consoles, earpieces, headsets, hearing aids, wearable display devices, security systems, and etc.

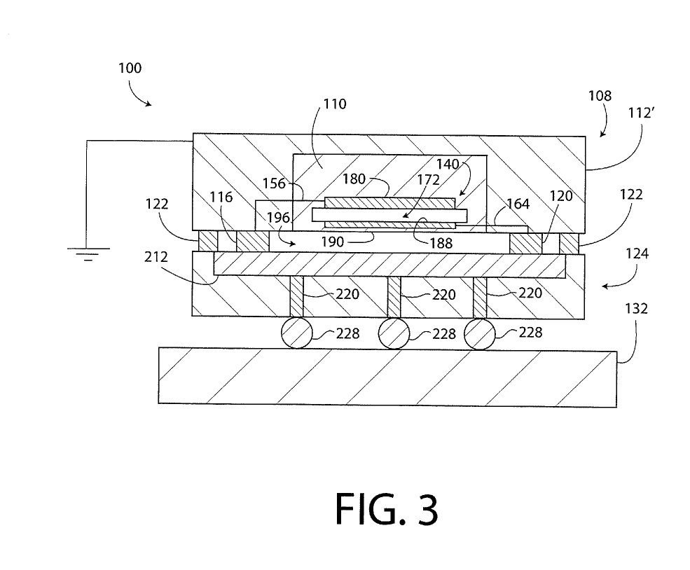

As shown in FIG. 3, the pressure sensor assembly 100 includes another embodiment of the shield portion 112′, which is bowl-shaped. In addition to being positioned over the pressure sensor 140, the shield portion 112′ is also positioned over side surfaces of the pressure sensor, such that the shield portion 112′ extends from the first side (upper side) of the pressure senor die 108′ to an opposite second side (lower side) the pressure sensor die. The pressure sensor assembly 100′ including the shield portion 112′ operates in the same way as the pressure sensor assembly 100.

It is noted that in some embodiments, the shield 112 is tunable to block a particular range of wavelengths/frequencies of electromagnetic radiation. For example, instead of being imperforate, the shield 112 may define openings (not shown) of a predetermined size that enable electromagnetic radiation less than a predetermined wavelength to pass therethrough.

As used herein, the terms above, below, upper, lower, and the like refer to relative positions/locations of portions of the pressure sensor assembly 100 and do not restrict the orientation of the pressure sensor assembly. For example, in FIG. 1 the pressure sensor assembly 100 is shown with the pressure sensor die 108 being located above the circuit die 124, but in other embodiments the pressure sensor die 108 may be oriented below the circuit die 124.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A pressure sensor assembly comprising:
a pressure sensor die including (i) a fixed electrode, (ii) a movable electrode located below the fixed electrode, and (iii) an electromagnetic shield located above the fixed electrode.

2. The pressure sensor assembly of claim 1, wherein the electromagnetic shield is electrically connected to ground.

3. The pressure sensor assembly of claim 2, wherein the electromagnetic shield includes a metallization coating.

4. The pressure sensor assembly of claim 2, wherein the electromagnetic shield includes a silicide layer.

5. The pressure sensor assembly of claim 2, wherein the electromagnetic shield includes a doped silicon layer that is electrically conductive.

6. The pressure sensor assembly of claim 1, wherein the electromagnetic shield is imperforate.

7. The pressure sensor assembly of claim 1, wherein:
the movable electrode is located on a first side of the pressure sensor die, and
the electromagnetic shield extends from the first side to an opposite second side of the pressure sensor die.

8. The pressure sensor assembly of claim 1, wherein:
the movable electrode is located on a first side of the pressure sensor die, and
the electromagnetic shield is spaced apart from the first side.

9. The pressure sensor assembly of claim 1, further comprising:
a circuit die including an ASIC configured to generate an electrical output corresponding to a pressure sensed by the pressure sensor die; and
a conducting member positioned between the pressure sensor die and the circuit die and configured to electrically connect the pressure sensor die to the circuit die.

10. The pressure sensor assembly of claim 1, wherein the electromagnetic shield defines an electrical resistivity less than or equal to one ohm·centimeter.

11. A pressure sensor assembly comprising:
a pressure sensor die including a MEMS pressure sensor and an electromagnetic shield layer; and
a circuit die including an ASIC configured to generate an electrical output corresponding to a pressure sensed by the MEMS pressure sensor, the ASIC being electrically connected to the pressure sensor die.

12. The pressure sensor assembly of claim 11, wherein the electromagnetic shield layer is electrically connected to ground.

13. The pressure sensor assembly of claim 11, wherein the electromagnetic shield is electrically conductive and is configured to shield the MEMS pressure sensor and the ASIC from electromagnetic radiation.

14. The pressure sensor assembly of claim 11, further comprising:
a bonding member positioned between the pressure sensor die and the circuit die, such that the pressure sensor die and the circuit die are arranged in a stacked configuration.

15. The pressure sensor assembly of claim 11, wherein:
the circuit die is configured for a bare-die connection to a substrate, and
the MEMS pressure sensor and the ASIC are located between the electromagnetic shield layer and the substrate.

16. The pressure sensor assembly of claim 11, wherein:
the MEMS pressure sensor includes a fixed electrode and a movable electrode located below the fixed electrode, and
the electromagnetic shield layer is located above the fixed electrode.

17. The pressure sensor assembly of claim 16, wherein:
the movable electrode is located on a first side of the pressure sensor die, and
the electromagnetic shield layer extends from the first side to an opposite second side of the pressure sensor die.

18. The pressure sensor assembly of claim 16, wherein:
the movable electrode is located on a first side of the pressure sensor die, and
the electromagnetic shield layer is spaced apart from the first side.

19. The pressure sensor assembly of claim 11, wherein the electromagnetic shield includes a doped silicon layer that is electrically conductive.

20. The pressure sensor assembly of claim 11, wherein the electromagnetic shield layer is imperforate.
